(19) United States
(12) Patent Application Publication
(10) Pub. No.: US 2024/0039258 A1
(43) Pub. Date: Feb. 1, 2024

(54) WIRE HARNESS

(71) Applicant: SUMITOMO WIRING SYSTEMS, LTD., Yokkaichi-shi, Mie (JP)

(72) Inventors: Katsutoshi IZAWA, Yokkaichi-shi (JP); Kosuke TANAKA, Yokkaichi-shi (JP); Ryuta SAITO, Yokkaichi-shi (JP)

(73) Assignee: SUMITOMO WIRING SYSTEMS, LTD., Yokkaichi-shi, Mie (JP)

(21) Appl. No.: 18/017,136

(22) PCT Filed: Jul. 5, 2021
(86) PCT No.: PCT/JP2021/025345

§ 371 Date: Jan. 20, 2023

(30) Foreign Application Priority Data
Jul. 22, 2020 (JP) 2020-125330
Oct. 5, 2020 (JP) 2020-168192
Feb. 12, 2021 (JP) 2021-021258
May 25, 2021 (JP) 2021-087655

(51) Int. Cl. H02G 3/04; B60R 16/02

(52) U.S. Cl. CPC H02G 3/0462; B60R 16/0215

(57) ABSTRACT

A wire harness including: an electric wire; an exterior tube that covers an outer circumference of the electric wire; and a route regulator that covers part of an outer circumference of the exterior tube in a circumferential direction of the exterior tube and extends in a length direction of the exterior tube, and regulates a wiring route of the electric wire.

### TECHNICAL FIELD

The present disclosure relates to a wire harness.

### BACKGROUND ART

A conventionally known wire harness includes: a corrugated tube that covers the outer circumference of an electric wire member; and a route regulating member that covers part of the corrugated tube in the circumferential direction and regulates the wiring route of the electric wire member (see, for example, Patent Document 1).

The corrugated tube in the wire harness described in Patent Document 1 has a slit formed in the length direction. The route regulating member includes a route maintenance member provided along the outer circumference of the corrugated tube, and an attachment member to be provided in the slit. The attachment member is configured to be locked to the inner circumferential side portion of the slit and the outer circumferential side portion of the route maintenance member. As a result of the corrugated tube, the route maintenance member, and the attachment member being fixed by winding a piece of tape or the like, the route of the electric wire member is regulated.

### CITATION LIST

### Patent Documents

Patent Document 1: JP 2013-55760A

### SUMMARY OF INVENTION

### Technical Problem

In the wire harness described in Patent Document 1, the attachment member is provided in the slit of the corrugated tube. Thus, there is a possibility that a gap will form between the attachment member and the slit. Such a gap is undesirable in terms of enhancing the water-sealing performance of the wire harness.

It is an object of the present disclosure to provide a wire harness that can suppress a decrease in water-sealing performance.

### Solution to Problem

A wire harness according to the present disclosure includes: an electric wire member; a tubular exterior member that covers an outer circumference of the electric wire member; and a route regulating member that covers part of an outer circumference of the exterior member in a circumferential direction of the exterior member and extends in a length direction of the exterior member, and regulates a wiring route of the electric wire member, wherein the route regulating member includes: an insertion slot that is open in a direction orthogonal to a length direction of the route regulating member and extends over the entire length of the route regulating member, and is configured to allow insertion of the exterior member; a first end portion and a second end portion that are located on opposite sides from each other in a circumferential direction of the route regulating member and form the insertion slot; and a protruding portion that protrudes from an inner surface of at least one of the first end portion and the second end portion toward the exterior member and comes into contact with an outer surface of the exterior member.

### Advantageous Effects of Invention

According to the present disclosure, it is possible to suppress a decrease in the water-sealing performance of the wire harness.

### BRIEF DESCRIPTION OF DRAWINGS

FIG. 1 is a schematic view showing a wire harness according to an embodiment.

FIG. 2 is a cross-sectional view showing the wire harness according to the embodiment.

FIG. 3 is an exploded perspective view showing an exterior member and a route regulating member of the wire harness according to the embodiment.

FIG. 4 is a front view showing the route regulating member according to the embodiment.

FIG. 5 is a front view showing a route regulating member according to a modification.

FIG. 6 is a front view showing a route regulating member according to a modification.

FIG. 7 is a front view showing a route regulating member according to a modification.

FIG. 8 is a front view showing a route regulating member according to a modification.

FIG. 9 is a sectional view showing a route regulating member according to a modification.

FIG. 10 is a cross-sectional view showing a wire harness according to a modification.

FIG. 11 is a cross-sectional view showing a wire harness according to a modification.

### DESCRIPTION OF EMBODIMENTS

### Description of Embodiments of the Present Disclosure

First, embodiments of the present disclosure will be listed and described below.

[1] A wire harness according to the present disclosure includes: an electric wire member; a tubular exterior member that covers an outer circumference of the electric wire member; and a route regulating member that covers part of an outer circumference of the exterior member in a circumferential direction of the exterior member and extends in a length direction of the exterior member, and regulates a wiring route of the electric wire member, wherein the route regulating member includes: an insertion slot that is open in a direction orthogonal to a length direction of the route regulating member and extends over the entire length of the route regulating member, and is configured to allow insertion of the exterior member; a first end portion and a second end portion that are located on opposite sides from each other in a circumferential direction of the route regulating member and form the insertion slot; and a protruding portion that protrudes from an inner surface of at least one of the first end portion and the second end portion toward the exterior member and comes into contact with an outer surface of the exterior member.

With this configuration, the route regulating member can be retrofitted to the outer circumference of the exterior member via the insertion slot. Since the route regulating member includes the protruding portion that protrudes from the inner surface of at least one of the first end portion and the second end portion and comes into contact with the outer surface of the exterior member, detachment of the route regulating member from the exterior member via the insertion slot can be suppressed. This makes it unnecessary to provide, in the exterior member, a slit or the like for attaching the route regulating member to the exterior member in order to regulate the route of the electric wire member covered with the exterior member. A decrease in the water-sealing performance of the wire harness can thus be suppressed.

[2] Preferably, the protruding portion extends in the length direction of the route regulating member.

With this configuration, the bending rigidity of the route regulating member can be enhanced. Moreover, with this configuration, the protruding portion comes into contact with the outer surface of the exterior member in a wide area in the length direction of the route regulating member. Therefore, the detachment of the route regulating member from the exterior member via the insertion slot can be suppressed in a wide area.

[3] Preferably, the protruding portion extends over the entire length of the route regulating member.

With this configuration, the protruding portion comes into contact with the outer surface of the exterior member over the entire length of the route regulating member. Therefore, the detachment of the route regulating member from the exterior member via the insertion slot can be suppressed over the entire length of the route regulating member.

[4] Preferably, the protruding portion protrudes from an inner surface of the first end portion and an inner surface of the second end portion.

With this configuration, the protruding portion is provided on two sides of the insertion slot in the circumferential direction of the route regulating member, so that the detachment of the route regulating member from the exterior member via the insertion slot can be further suppressed.

[5] Preferably, the protruding portion is a first protruding portion, and the route regulating member includes: a connection portion that connects the first end portion and the second end portion; and a second protruding portion that protrudes from an inner surface of the connection portion toward the exterior member and contacts the outer surface of the exterior member.

With this configuration, the route regulating member includes the second protruding portion, and thus the first protruding portion and the second protruding portion both come into contact with the outer surface of the exterior member. This can suppress rattling of the route regulating member against the exterior member.

[6] Preferably, the second protruding portion extends in the length direction of the route regulating member.

With this configuration, the bending rigidity of the route regulating member can be enhanced. Moreover, with this configuration, the second protruding portion comes into contact with the outer surface of the exterior member in a wide area in the length direction of the route regulating member. Therefore, the rattling of the route regulating member against the exterior member can be suppressed in a wide area.

[7] Preferably, the second protruding portion extends over the entire length of the route regulating member.

With this configuration, the second protruding portion comes into contact with the outer surface of the exterior member over the entire length of the route regulating member. Therefore, the rattling of the route regulating member against the exterior member can be suppressed over the entire length of the route regulating member.

[8] Preferably, the route regulating member includes a groove portion that is located on an outer surface of the connection portion at a part where the second protruding portion is located and that extends along the second protruding portion over the entire length of the route regulating member.

With this configuration, the thickness of the part of the connection portion where the second protruding portion is located is smaller than the case where the groove portion is not provided. Accordingly, the connection portion can easily deform toward the outer circumferential side with the groove portion serving as the starting point, thus facilitating widening of the insertion slot. This makes it easier to insert the exterior member into the route regulating member via the insertion slot.

[9] Preferably, the protruding portion protrudes from an inner surface of at least one of a leading end of the first end portion and a leading end of the second end portion.

With this configuration, the detachment of the route regulating member from the exterior member via the insertion slot can be further suppressed as compared with, for example, the case where the protruding portion protrudes from the inner surface at a position slightly distanced from the leading end of the first end portion or the leading end of the second end portion.

[10] Preferably, a leading end of the first end portion and a leading end of the second end portion are curved as viewed from the length direction of the route regulating member.

With this configuration, the leading end of the first end portion and the leading end of the second end portion are curved as viewed from the length direction of the route regulating member, so that the exterior member can be smoothly inserted into the route regulating member. In addition, the exterior member is kept from being damaged when being inserted into the route regulating member.

[11] Preferably, the protruding portion is made of a material softer than another part of the route regulating member.

With this configuration, the protruding portion is made of a material softer than another part of the route regulating member, and thus is likely to come into intimate contact with the exterior member. Detachment of the route regulating member from the exterior member can thus be further suppressed.

[12] Preferably, the route regulating member is made of metal, and the protruding portion is formed by bending the route regulating member.

With this configuration, the route regulating member is made of metal, so that the temperature inside the exterior member and the temperature of the electric wire member can be kept from increasing, for example, in the case where the wire harness is located near a heat source of a vehicle. Moreover, since the protruding portion is formed by bending the route regulating member, for example, the route regulating member having the protruding portion can be easily manufactured from a metal plate member.

[13] Preferably, the exterior member is flat-shaped, and the route regulating member has a flat shape that matches a shape of the outer circumference of the exterior member.

With this configuration, the foregoing effects can be equally achieved when the exterior member and the route regulating member are flat-shaped.

[14] Preferably, a length of the route regulating member in a first direction is longer than a length of the route regulating member in a second direction, where the first direction is a direction orthogonal to the length direction of the route regulating member, and the second direction is a direction orthogonal to the length direction of the route regulating member and the first direction, and the insertion slot is open in the first direction.

With this configuration, the insertion slot is open in the first direction, so that the length of the route regulating member in the second direction can be shortened as compared with, for example, a structure in which the insertion slot is open in the second direction. Moreover, the insertion slot can be easily widened and the route regulating member can be easily retrofitted to the exterior member via the insertion slot as compared with, for example, a structure in which the insertion slot is open in the second direction.

[15] Preferably, a length of the route regulating member in a first direction is longer than a length of the route regulating member in a second direction, where the first direction is a direction orthogonal to the length direction of the route regulating member, and the second direction is a direction orthogonal to the length direction of the route regulating member and the first direction, and the insertion slot is open in the second direction.

With this configuration, the insertion slot is open in the second direction, so that the length of the route regulating member in the first direction can be shortened as compared with, for example, a structure in which the insertion slot is open in the first direction. Moreover, for example, in the case of routing the wire harness so as to pass under the floor of a vehicle, by setting the opening direction of the insertion slot to the antigravity direction, the exterior member can be kept from falling out from the route regulating member and the wire harness can be suitably routed.

[16] Preferably, the exterior member is a corrugated tube that is flexible and is sealed over the entire circumference of the exterior member.

With this configuration, the exterior member can be deformed according to the wiring route of the electric wire member. Moreover, since the exterior member is sealed over the entire circumference thereof, the water-sealing performance of the exterior member can be enhanced. Both the routing performance and the water-sealing performance of the wire harness can thus be improved.

### Details of Embodiments of the Present Disclosure

Specific examples of the wire harness according to the present disclosure will be described below with reference to the drawings. In each drawing, part of a structure may be exaggerated or simplified for convenience of explanation. In addition, the dimensional ratio of each part may differ among the drawings. The present disclosure is not limited to these examples, but is defined by the claims and intended to include all modifications within the meaning and scope equivalent to the claims. The term “orthogonal” as used herein includes not only being exactly orthogonal but also being substantially orthogonal within the range in which the functions and effects according to the embodiment are achieved.

### Overall Configuration of Wire Harness 10

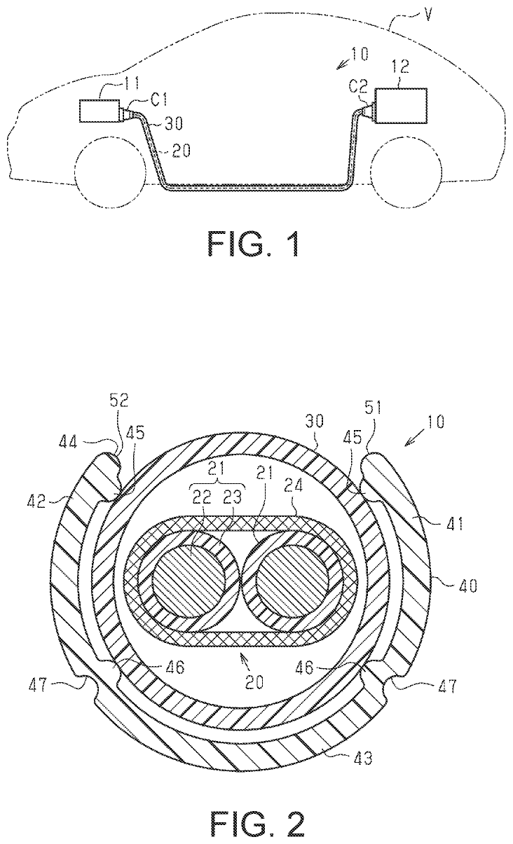

A wire harness 10 shown in FIG. 1 electrically connects two or more electric devices. For example, the wire harness 10 electrically connects an inverter 11 installed in the front portion of a vehicle V such as a hybrid vehicle or an electric vehicle and a high-voltage battery 12 installed rearward of the inverter 11 in the vehicle V. The wire harness 10 is, for example, routed so as to pass under the floor of the vehicle V. For example, the wire harness 10 is routed so that an intermediate portion of the wire harness 10 in the length direction extends outside the vehicle interior such as under the floor of the vehicle V.

The inverter 11 is connected to a wheel driving motor (not shown) that is a motive source for causing the vehicle to travel. The inverter 11 generates AC power from DC power of the high-voltage battery 12, and supplies the AC power to the motor. The high-voltage battery 12 is, for example, a battery capable of supplying a voltage of several hundred volts.

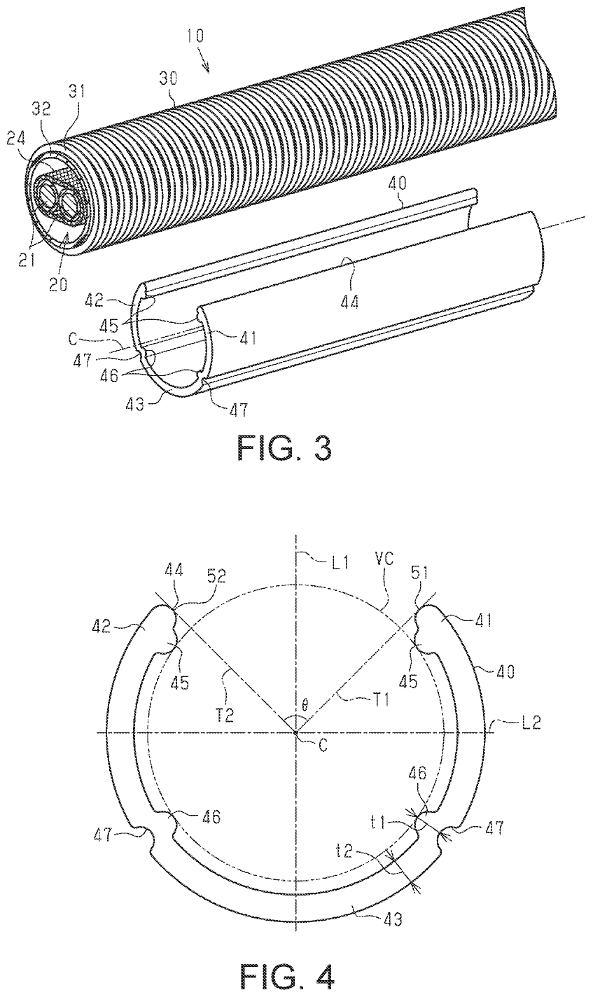

As shown in FIGS. 1 and 2, the wire harness 10 includes an electric wire member 20 that electrically connects the electric devices, a tubular exterior member 30 that covers the outer circumference of the electric wire member 20, and a route regulating member 40 that covers the outer circumference of the exterior member 30 and regulates a route (hereafter referred to as a “wiring route”) along which the electric wire member 20 is routed. A pair of connectors C1 and C2 are respectively attached to two ends of the electric wire member 20.

### Structure of Electric Wire Member 20

The electric wire member 20 includes one or more electric wires 21 and a braided member 24 that collectively covers the outer circumference of each electric wire 21. The electric wire member 20 in this embodiment includes two electric wires 21. One end of the electric wire member 20 is connected to the inverter 11 via the connector C1, and the other end of the electric wire member 20 is connected to the high-voltage battery 12 via the connector C2. For example, the electric wire member 20 is elongated so as to extend in the front-rear direction of the vehicle. Each electric wire 21 is, for example, a high-voltage electric wire that can handle high voltages and large currents. Each electric wire 21 may be, for example, a non-shielded electric wire that does not have an electromagnetic shield structure, or a shielded electric wire that has an electromagnetic shield structure.

### Configuration of Electric Wire 21

As shown in FIG. 2, each electric wire 21 is a coated electric wire including a core wire 22 formed by a conductor and an insulating coating 23 covering the outer circumference of the core wire 22.

### Configuration of Core Wire 22

As the core wire 22, for example, a stranded wire formed by twisting a plurality of metal strands together, a columnar conductor made of a single columnar metal rod having a solid structure, or a tubular conductor having a hollow structure may be used. As the core wire 22, for example, a combination of a plurality of types of conductors such as a stranded wire, a columnar conductor, and a tubular conductor may be used. Examples of the columnar conductor include a single core wire and a bus bar. The core wire 22 in this embodiment is a stranded wire. As the material of the core wire 22, for example, a metal material such as a copper-based or aluminum-based material may be used.

The cross-sectional shape (hereafter referred to as “transverse cross-sectional shape”) of the core wire 22 taken along a plane orthogonal to the length direction of the core wire 22, that is, the length direction of the electric wire 21, may be any shape. Examples of the transverse cross-sectional shape of the core wire 22 include a circular shape, a semi-circular shape, a polygonal shape, a square shape, and a flat shape. The transverse cross-sectional shape of the core wire 22 in this embodiment is a circular shape.

The term “flat shape” as used herein includes, for example, a rectangle, an oval, and an ellipse. The term “rectangle” as used herein refers to a shape having long and short sides, and excludes a square. The term “rectangle” as used herein includes a shape in which ridges are chamfered and a shape in which ridges are rounded. The term “oval” as used herein refers to a shape consisting of two parallel lines of substantially equal length and two semi-circles.

### Configuration of Insulation Coating 23

The insulation coating 23 covers, for example, the outer circumferential surface of the core wire 22 over the entire circumference thereof. The insulating coating 23 is made of an insulating material such as a synthetic resin, for example. As the material of the insulating coating 23, for example, a synthetic resin mainly containing a polyolefin resin such as crosslinked polyethylene or crosslinked polypropylene may be used. As the material of the insulating coating 23, one type of material may be used alone, or two or more types of materials may be used in combination as appropriate.

### Configuration of Braided Member 24

The braided member 24 has, for example, a tubular shape that collectively covers the outer circumference of each electric wire 21. The braided member 24 is provided, for example, so as to cover the outer circumference of each electric wire 21 substantially over the entire length of the electric wires 21. As the braided member 24, a braided wire obtained by braiding a plurality of metal strands or a braided wire obtained by braiding metal strands and resin strands together may be used. As the material of the metal strands, for example, a metal material such as a copper-based or aluminum-based material may be used. As the resin strands, for example, reinforced fibers having excellent insulation properties and shear resistance such as para-aramid fibers may be used. While not shown, the braided member 24 is grounded, for example, at each of the connectors C1 and C2.

### Configuration of Exterior Member 30

As shown in FIG. 3, the exterior member 30 has a cylindrical shape that covers the outer circumference of the electric wire member 20 over the entire circumference thereof. The exterior member 30 is sealed over the entire circumference thereof. The exterior member 30 is provided, for example, so as to cover the outer circumference of part of the electric wire member 20 in the length direction. The exterior member 30 in this embodiment is a corrugated tube having a bellows structure in which annular protrusions 31 and annular depressions 32 are alternately arranged in the length direction. The exterior member 30 is flexible.

As the material of the exterior member 30, for example, a conductive resin material or a non-conductive resin material may be used. As the resin material, for example, a synthetic resin such as polyolefin, polyamide, polyester, or ABS resin may be used.

### Configuration of Route Regulation Member 40

As shown in FIGS. 2 and 3, the route regulating member 40 covers part of the outer circumferential surface of the exterior member 30 in the circumferential direction of the exterior member 30 and extends in the length direction of the exterior member 30. The route regulating member 40 covers an area larger than half of the outer circumference of the exterior member 30. The route regulating member 40 in this embodiment is attached to, for example, the outer circumference of a linearly extending part of the exterior member 30 under the floor of the vehicle V or the like on the wiring route of the electric wire member 20.

As the material of the route regulating member 40, for example, a synthetic resin such as polypropylene, polyamide, or polyacetal may be used. The route regulating member 40 can be manufactured using a well-known manufacturing method such as extrusion molding or injection molding.

The route regulating member 40 includes: an insertion slot 44 that is open in a direction orthogonal to the length direction of the route regulating member 40; a first end portion 41 and a second end portion 42 that form the insertion slot 44; and a connection portion 43 that connects the first end portion 41 and the second end portion 42. In other words, the route regulating member 40 includes the connection portion 43 formed so as to cover part of the exterior member 30 in the circumferential direction, the first end portion 41 and the second end portion 42 provided at two ends of the connection portion 43, and the insertion slot 44 formed by the first end portion 41 and the second end portion 42.

The first end portion 41 and the second end portion 42 are located on opposite sides from each other in the circumferential direction of the route regulating member 40. The first end portion 41 and the second end portion 42 are separated from each other with the insertion slot 44 therebetween, in the circumferential direction of the route regulating member 40.

The transverse cross-sectional shapes of the first end portion 41, the second end portion 42, and the connection portion 43 are an arc shape centered around a central axis C. The transverse cross-sectional shape of the route regulating member 40 is therefore substantially C-shaped as a whole. The transverse cross-sectional shape of the route regulating member 40 is the same over the entire length of the route regulating member 40.

In the following description, the direction in which the central axis C of the route regulating member 40 extends is simply referred to as the “length direction”, and the circumferential direction of the route regulating member 40 centered around the central axis C is simply referred to as the “circumferential direction”.

The insertion slot 44 extends over the entire length of the route regulating member 40. The opening width of the insertion slot 44, that is, the shortest distance between the first end portion 41 and the second end portion 42, is smaller than the outer diameter of the exterior member 30.

Inserting the exterior member 30 into the insertion slot 44 from a direction orthogonal to the length direction of the exterior member 30 causes the route regulating member 40 to deform elastically and the opening width of the insertion slot 44 to increase. Once the exterior member 30 has moved into the route regulating member 40, the route regulating member 40 elastically returns to its original shape (also referred to as the natural shape, natural state, or non-elastically-deformed state of the route regulating member 40). Thus, the opening width returns to the original width, as a result of which the route regulating member 40 is attached to the exterior member 30. Here, in a state in which the exterior member 30 is inserted into the route regulating member 40, the opening width may not always return to the exact original width, and may be slightly larger than the original width as a result of the exterior member 30 hindering the elastic deformation of the route regulating member 40 trying to return to the original shape. Moreover, in a state in which the exterior member 30 is inserted into the route regulating member 40, the exterior member 30 may bend and consequently the opening width may return to the original width. Thus, the opening width in a state in which the exterior member 30 is inserted into the route regulating member 40 depends on the rigidity, flexibility, and the like of the exterior member 30 and the route regulating member 40. FIG. 2 schematically shows the state of the exterior member 30 and the route regulating member 40, and does not strictly show the bent state of the exterior member 30 and the route regulating member 40 in a state in which the exterior member 30 is inserted in the route regulating member 40.

In the following description, as shown in FIG. 4, the tangent line of the first end portion 41 passing through the central axis C is denoted as “tangent line T1” and the tangent line of the second end portion 42 passing through the central axis C is denoted as “tangent line T2”, in a front view orthogonal to the length direction. Further, the axis bisecting the opening width of the insertion slot 44 and passing through the central axis C is denoted as “axis L1” and the axis orthogonal to the axis L1 and passing through the central axis C is denoted as “axis L2”, in the front view.

To attach the route regulating member 40 to the exterior member 30 in this embodiment, for example, the opening angle θ of the insertion slot 44 is preferably in the range of 60° to 120°. The opening angle θ in this embodiment is 90°. The term “opening angle θ” as used herein is the angle formed by the tangent line T1 and the tangent line T2 in the front view.

The first end portion 41 and the second end portion 42 in this embodiment are portions of the route regulating member 40 located closer to the insertion slot 44 relative to the axis L2 in the direction in which the axis L1 extends, in the front view. The connection portion 43 is a portion of the route regulating member 40 located farther from the insertion slot 44 relative to the axis L2 in the direction in which the axis L1 extends, in the front view.

As shown in FIGS. 2 to 4, the route regulating member 40 includes a pair of first protruding portions 45 that protrude toward the exterior member 30 and come into contact with the outer surface of the exterior member 30, more specifically, outer surfaces of the annular protrusions 31. One of the pair of first protruding portions 45 protrudes from the inner surface of the first end portion 41. The other one of the pair of first protruding portions 45 protrudes from the inner surface of the second end portion 42. The transverse cross-sectional shape of each first protruding portion 45 is, for example, a semi-circular shape. Each first protruding portion 45 extends in the length direction of the route regulating member 40 over its entire length.

The respective first protruding portions 45 are located farther from the insertion slot 44 than a leading end 51 of the first end portion 41 and a leading end 52 of the second end portion 42 are in the circumferential direction. The leading end 51 of the first end portion 41 and the leading end 52 of the second end portion 42 are curved as viewed from the length direction of the route regulating member 40. In other words, the transverse cross-sectional shape of each of the leading end 51 of the first end portion 41 and the leading end 52 of the second end portion 42 is a curved shape. Specifically, the transverse cross-sectional shape of each of the leading end 51 of the first end portion 41 and the leading end 52 of the second end portion 42 is a semi-circular shape.

The route regulating member 40 includes a pair of second protruding portions 46 that protrude toward the exterior member 30 and come into contact with the outer surface of the exterior member 30, more specifically, outer surfaces of the annular protrusions 31. The second protruding portions 46 protrude from the inner surface of the connection portion 43. The second protruding portions 46 are spaced apart from each other in the circumferential direction. The transverse cross-sectional shape of each second protruding portion 46 is, for example, a semi-circular shape. Each second protruding portion 46 extends in the length direction of the route regulating member 40 over the entire length thereof.

As shown in FIG. 4, the first protruding portion 45 located at the first end portion 41 and one second protruding portion 46 face each other in the radial direction of the route regulating member 40. More specifically, the first protruding portion 45 and the second protruding portion 46 are located on opposite sides of the central axis C. The first protruding portion 45 located at the second end portion 42 and the other second protruding portion 46 face each other in the radial direction. More specifically, the first protruding portion 45 and the second protruding portion 46 are located on opposite sides of the central axis C.

The protrusion amounts of the first protruding portions 45 from the inner surface of the first end portion 41 and the inner surface of the second end portion 42 and the protrusion amounts of the second protruding portions 46 from the inner surface of the connection portion 43 are equal. The first protruding portions 45 and the second protruding portions 46 are located on the same virtual circle VC centered around the central axis C. The virtual circle VC shown in FIG. 4 is a circle connecting the leading ends of the first protruding portions 45 and the second protruding portions 46. FIG. 4 shows the route regulating member 40 (the route regulating member 40 in the natural state) where it is not attached to the exterior member 30 and is not elastically deformed.

The route regulating member 40 in this embodiment presses the outer surface of the exterior member 30 using the first protruding portions 45 and the second protruding portions 46. This prevents the route regulating member 40 from moving relative to the exterior member 30 in the length direction. In this embodiment, the diameter of the virtual circle VC is smaller than the diameter of the exterior member 30 in order to press the outer surface of the exterior member 30 using the first protruding portions 45 and the second protruding portions 46.

As shown in FIG. 2, since the first protruding portions 45 and the second protruding portions 46 come into contact with the outer surface of the exterior member 30, a gap is formed between the outer surface of the exterior member 30 and the inner surface of each of the first end portion 41, the second end portion 42, and the connection portion 43. The gaps are formed spanning the entire length of the route regulating member 40.

As shown in FIGS. 3 and 4, the route regulating member 40 includes a pair of groove portions 47 on the outer surface of the connection portion 43 at portions where the second protruding portions 46 are located. Each groove portion 47 extends along the corresponding second protruding portion 46, i.e. in the length direction, over the entire length of the route regulating member 40. The transverse cross-sectional shape of each groove portion 47 is, for example, a semi-circular shape.

The thickness t1 of each part of the connection portion 43 where the groove portion 47 is provided is substantially the same as the thickness t2 of the other part of the connection portion 43. The thickness t1 may be larger or smaller than the thickness t2.

Operation of this embodiment is described below.

With the wire harness 10 in this embodiment, the route regulating member 40 can be retrofitted to the outer circumference of the exterior member 30 via the insertion slot 44. Since the route regulating member 40 includes the pair of first protruding portions 45 that come into contact with the outer surface of the exterior member 30, detachment of the route regulating member 40 from the exterior member 30 via the insertion slot 44 can be suppressed. This makes it unnecessary to provide, in the exterior member 30, a slit or the like for attaching the route regulating member 40 to the exterior member 30 in order to regulate the route of the electric wire member 20 covered by the exterior member 30.

Effects according to this embodiment are described below.

(1) The route regulating member 40 includes the pair of first protruding portions 45 respectively protruding from the inner surface of the first end portion 41 and the inner surface of the second end portion 42. With such a configuration, the foregoing functions can be achieved. Specifically, detachment of the route regulating member 40 from the exterior member 30 can be suppressed, and there is no need to provide a slit or the like in the exterior member 30. Thus, a decrease in the water-sealing performance of the wire harness 10 can be suppressed.

(2) Each first protruding portion 45 extends overt the entire length of the route regulating member 40. With such a configuration, the bending rigidity of the route regulating member 40 can be enhanced. Moreover, each first protruding portion 45 comes into contact with the outer surface of the exterior member 30 over the entire length of the route regulating member 40. Therefore, detachment of the route regulating member 40 from the exterior member 30 via the insertion slot 44 can be suppressed over the entire length of the route regulating member 40.

(3) The route regulating member 40 includes the pair of second protruding portions 46 protruding from the inner surface of the connection portion 43. With such a configuration, the first protruding portions 45 and the second protruding portions 46 both come into contact with the outer surface of the exterior member 30. This can suppress rattling of the route regulating member 40 against the exterior member 30.

(4) The second protruding portions 46 extend over the entire length of the route regulating member 40. With such a configuration, the bending rigidity of the route regulating member 40 can be enhanced. Moreover, the second protruding portions 46 come into contact with the outer surface of the exterior member 30 over the entire length of the route regulating member 40. Therefore, the rattling of the route regulating member 40 against the exterior member 30 can be suppressed over the entire length of the route regulating member 40.

(5) The transverse cross-sectional shape of the route regulating member 40 is the same over the entire length of the route regulating member 40. With such a configuration, the route regulating member 40 can be easily manufactured using an extruder that extrudes the raw material of the route regulating member 40 in the length direction. A plurality of types of route regulating members 40 that differ in length in the length direction can be manufactured using a single extruder.

(6) The route regulating member 40 includes the groove portions 47 respectively extending along the second protruding portions 46 over the entire length of the route regulating member 40. With such a configuration, the thickness t1 of each part of the connection portion 43 where the second protruding portion 46 is located is smaller compared to a case where the groove portions 47 are not provided. Accordingly, the connection portion 43 can easily deform toward the outer circumferential side with the groove portions 47 serving as the starting point, thus facilitating widening of the insertion slot 44. This makes it easier to insert the exterior member 30 into the route regulating member 40 via the insertion slot 44.

(7) The exterior member 30 is a corrugated tube. With such a configuration, the exterior member 30 can be deformed according to the wiring route of the electric wire member 20. Moreover, since the exterior member 30 is sealed over the entire circumference thereof, the water-sealing performance of the exterior member 30 can be enhanced. Both the routability and the water-sealing performance of the wire harness 10 can thus be improved.

(8) The leading end 51 of the first end portion 41 and the leading end 52 of the second end portion 42 are curved as viewed from the length direction of the route regulating member 40, and thus the exterior member 30 can be smoothly inserted into the route regulating member 40. In addition, the exterior member 30 is unlikely to be damaged when inserted into the route regulating member 40.

### MODIFICATIONS

The following modifications can be made to the foregoing embodiment. The foregoing embodiment and the modifications described below may be combined provided no technical contradiction arises.

The exterior member 30 may be formed by providing a metal layer containing a metal material on the outer surface of the corrugated tube. Such a metal layer can be provided, for example, using a plating process. The metal layer is preferably provided on the all outer surfaces of the annular protrusions 31 and the annular depressions 32 of the corrugated tube. For example, a metal material such as aluminum having low emissivity is preferably used for the outermost surface of the metal layer. With such a configuration, for example, it is possible to suppress an increase in the temperature inside the exterior member 30 and the temperature of the electric wire member 20 caused by radiation from a heat source of the vehicle.
The exterior member 30 may have a slit extending in the length direction of the exterior member 30. In this case, it is sufficient that the exterior member 30 is sealed over the entire circumference thereof by, for example, winding a piece of tape around the exterior member 30 so as to close off the slit over the entire length of the exterior member 30. A decrease in the water-sealing performance of the exterior member 30 having a slit can thus be suppressed.
At least one of the groove portions 47 may be omitted.
The first protruding portions 45 and the second protruding portions 46 may not extend over the entire length of the route regulating member 40. For example, the first protruding portions 45 and the second protruding portions 46 may extend over a portion of the route regulating member 40 in the length direction, or extend over part of the circumference of the route regulating member 40. The first protruding portions 45 and the second protruding portions 46 may be, for example, hemispherical protrusions.
The number of first protruding portions 45 and the number of second protruding portions 46 may be changed as appropriate. For example, a plurality of first protruding portions 45 may be spaced from each other in the length direction or the circumferential direction, and a plurality of second protruding portions 46 may be spaced from each other in the length direction.
The positions of the first protruding portions 45 and the second protruding portions 46 may be changed as appropriate. For example, the first protruding portions 45 may protrude from the leading ends of the first end portion 41 and the second end portion 42. The first protruding portions 45 and the second protruding portions 46 need not be located on opposite sides of the central axis C.
The second protruding portions 46 may be omitted. In this case, the outer surface of the exterior member 30 comes into contact with the first protruding portions 45 and the inner surface of the connection portion 43.

For example, as shown in FIG. 6, the route regulating member 40 may not include the second protruding portions 46 protruding from the connection portion 43, and the transverse cross-sectional shape of the connection portion 43 may be simply an arc shape. In this case, the outer surface of the exterior member 30 comes into contact with the first protruding portions 45 and the inner surface 48 of the connection portion 43.

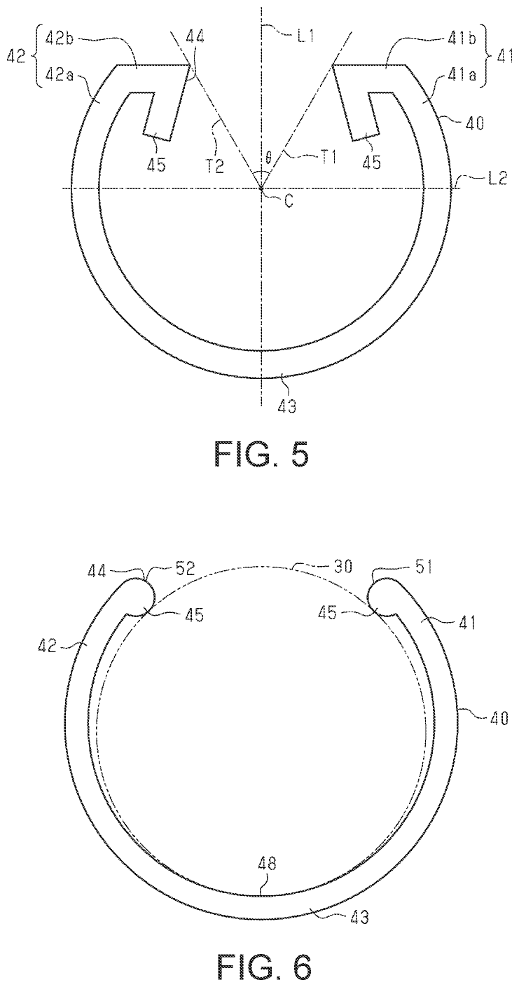

In the route regulating member 40 shown in FIG. 6, the first protruding portions 45 respectively protrude from the inner surfaces of the leading end 51 of the first end portion 41 and the leading end 52 of the second end portion 42. With this configuration, detachment of the route regulating member 40 from the exterior member 30 via the insertion slot 44 can be further suppressed as compared with, for example, the foregoing embodiment in which the first protruding portions 45 protrude from the inner surface of the route regulating member 40 at positions slightly distanced from the leading end 51 of the first end portion 41 and the leading end 52 of the second end portion 42.
As shown in FIG. 5, the first end portion 41 may include a circular arc portion 41a whose transverse cross-sectional shape is an arc shape centered around the central axis C, and an extending portion 41b bent from the circular arc portion 41a and extending toward the second end portion 42. Likewise, the second end portion 42 may include a circular arc portion 42a whose transverse cross-sectional shape is an arc shape centered around the central axis C, and an extending portion 42b bent from the circular arc portion 42a and extending toward the first end portion 41. The extending portions 41b and 42b extend along the axis L2 so as to approach each other. The first protruding portions 45 in this modification respectively protrude from the inner surfaces of the leading ends of the extending portions 41b and 42b. Each first protruding portion 45 is inclined with respect to the axis L1 so as to be located more outward in the radial direction of the route regulating member 40 in a direction toward the central axis C. That is, the first protruding portions 45 are inclined so as to be distanced from each other in a direction toward the central axis C. Hence, when attaching the route regulating member 40 to the exterior member 30, the exterior member 30 can be easily guided into the route regulating member 40 using the first protruding portions 45.
A first protruding portion 45 may protrude from the inner surface of only one of the first end portion 41 and the second end portion 42. In this case, the second protruding portion 46 is preferably located on the opposite side of the central axis C from the first protruding portion 45.
The route regulating member 40 may be made of a metal material such as an iron-based, copper-based, or aluminum-based material. In this case, the opening angle θ of the insertion slot 44, the thickness of the route regulating member 40, and the like may be adjusted so that the route regulating member 40 does not plastically deform when the insertion slot 44 is widened.

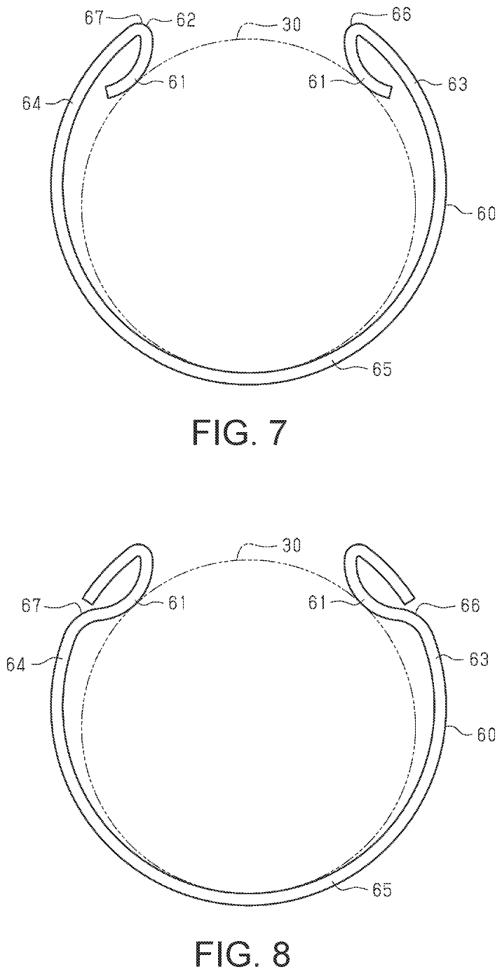

For example, as shown in FIG. 7, a route regulating member 60 may be made of metal, and first protruding portions 61 may be formed by bending the route regulating member 60.

Specifically, the route regulating member 60 is formed by a metal plate member. The route regulating member 60 includes an insertion slot 62 that is open in a direction orthogonal to the length direction of the route regulating member 60, a first end portion 63 and a second end portion 64 that form the insertion slot 62, and a connection portion 65 that connects the first end portion 63 and the second end portion 64, as with the route regulating member 40 in the foregoing embodiment. In other words, the route regulating member 60 includes the connection portion 65 formed so as to cover part of the exterior member 30 in the circumferential direction, the first end portion 63 and the second end portion 64 provided at two ends of the connection portion 65, and the insertion slot 62 formed by the first end portion 63 and the second end portion 64.

The route regulating member 60 includes the first protruding portions 61 that respectively protrude from the inner surfaces of the first end portion 63 and the second end portion 64 toward the exterior member 30 and come into contact with the outer surface of the exterior member 30. The first protruding portions 61 are formed by bending the route regulating member 60. Specifically, the first protruding portions 61 are respectively folded back from the leading end 66 of the first end portion 63 and the leading end 67 of the second end portion 64 and rolled to the inside of the route regulating member 60.

For example, as shown in FIG. 8, the first protruding portions 61 may be bent so as to protrude to the inside of the route regulating member 60 while respectively extending in the circumferential direction from the leading end 66 of the first end portion 63 and the leading end 67 of the second end portion 64 and then folded back and rolled outward.

With these configurations, since the route regulating member 60 is made of metal, an increase in the temperature inside the exterior member 30 and the temperature of the electric wire member 20 can be suppressed, for example, in the case where the wire harness is installed near a heat source of the vehicle. Moreover, since the first protruding portions 61 are formed by bending the route regulating member 60, the route regulating member 60 having the first protruding portions 61 can be easily manufactured from, for example, a metal plate material member.
The first protruding portions 45 of the route regulating member 40 may be made of a material softer than the other parts of the route regulating member 40. Specifically, the first protruding portions 45 may be made of a material softer than the other parts of the route regulating member 40 in Rockwell hardness, for example.

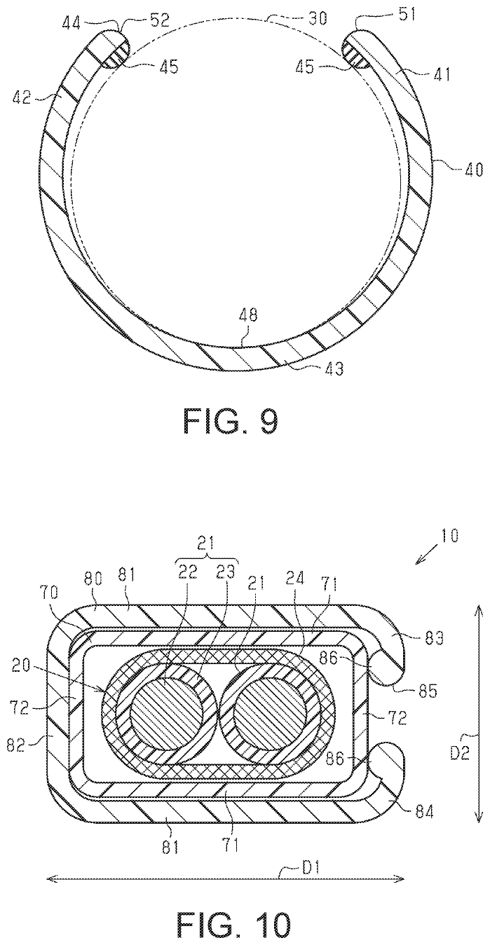

For example, as shown in FIG. 9, the first protruding portions 45 may be made of a material softer than other parts of the route regulating member 40, i.e. the first end portion 41, the second end portion 42, and the connection portion 43. Specifically, for example, the first end portion 41, the second end portion 42, and the connection portion 43 may be made of a synthetic resin such as polypropylene, polyamide, or polyacetal, and the first protruding portions 45 may be made of an elastomer. In this case as well, the route regulating member 40 may be manufactured using a manufacturing method such as extrusion molding or injection molding.

The first protruding portions 45 may be made of rubber. The first protruding portions 45 may be provided on a molded product including the first end portion 41, the second end portion 42, and the connection portion 43 through insert molding. The first protruding portions 45 may be fixed to a molded product including the first end portion 41, the second end portion 42, and the connection portion 43 using adhesion.

The first protruding portions 45 may be made of a soft resin that is softer than other parts of the route regulating member 40.

Since the first protruding portions 45 are made of a material softer than other parts of the route regulating member 40, the first protruding portions 45 are likely to come into intimate contact with the exterior member 30. Detachment of the route regulating member 40 from the exterior member 30 can thus be further suppressed.

The exterior member 30 may have a flat transverse cross-sectional shape. In this case, the route regulating member 40 may be flat-shaped along the shape of the outer circumference of the exterior member 30.

For example, as shown in FIG. 10, an exterior member 70 and a route regulating member 80 may be flat-shaped. The exterior member 70 in this example is a rectangular corrugated tube as viewed from the length direction of the exterior member 70. Specifically, the exterior member 70 includes a pair of parallel exterior longitudinal components 71, and a pair of exterior lateral components 72 that are shorter than the pair of exterior longitudinal components 71 and connect the pair of exterior longitudinal components 71 at two ends thereof, as viewed from the length direction of the exterior members 70.

The route regulating member 80 includes a pair of longitudinal components 81 respectively extending along the exterior longitudinal components 71, and a lateral component 82 extending along one exterior lateral component 72 and connecting the pair of longitudinal components 81 at one end thereof. The route regulating member 80 also includes a first end portion 83 and a second end portion 84 extending in a direction approaching each other from the other ends of the pair of longitudinal components 81, and an insertion slot 85 formed by the first end portion 83 and the second end portion 84. The route regulating member 80 also includes first protruding portions 86 that respectively protrude from the inner surfaces of the first end portion 83 and the second end portion 84 toward the exterior member 70 and come into contact with the outer surface of the exterior member 70.

A direction orthogonal to the length direction of the route regulating member 80 is defined as a first direction D1. A direction orthogonal to the length direction of the route regulating member 80 and the first direction D1 is defined as a second direction D2. The length of the route regulating member 80 in the first direction D1 is longer than the length of the route regulating member 80 in the second direction D2. That is, the pair of longitudinal components 81 extend in the first direction D1, and the lateral component 82 extends in the second direction D2. The longitudinal components 81 are longer than the lateral component 82. The insertion slot 85 is open in the first direction D1. That is, the insertion slot 85 is provided between the pair of longitudinal components 81 on the opposite side from the lateral component 82.

With this configuration as well, the route regulating member 80 can be retrofitted to the outer circumference of the exterior member 70 via the insertion slot 85. Detachment of the route regulating member 80 from the exterior member 70 can be suppressed, and there is no need to provide a slit or the like in the exterior member 70. A decrease in the water-sealing performance of the wire harness 10 can thus be suppressed.

Moreover, the length of the route regulating member 80 in the second direction D2 can be shortened as compared with, for example, a structure in which the insertion slot 85 is open in the second direction D2. Specifically, in the case where the insertion slot is open in the second direction D2, the protruding portions protrude in the second direction D2. This causes an increase in the length of the route regulating member 80 in the second direction D2. The configuration in this example can avoid such a problem and the length of the route regulating member 80 in the second direction D2 can be shortened.

Moreover, the longitudinal components 81 can be easily bent to widen the insertion slot 85 as compared with, for example, a structure in which the insertion slot 85 is open in the second direction D2. Hence, the route regulating member 80 can be easily retrofitted to the exterior member 70 via the insertion slot 85.

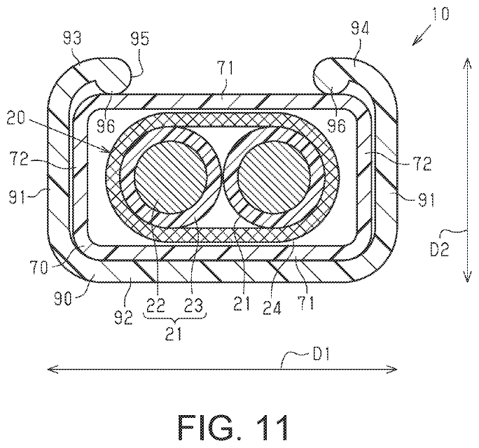

For example, as shown in FIG. 11, the exterior member 70 and a route regulating member 90 may be flat-shaped.

The route regulating member 90 in this example includes a pair of lateral components 91 extending along the respective exterior lateral components 72, and a longitudinal component 92 extending along one exterior longitudinal component 71 and connecting the pair of lateral components 91 at one end thereof. The route regulating member 90 also includes a first end portion 93 and a second end portion 94 extending in a direction approaching each other from the other ends of the pair of lateral components 91, and an insertion slot 95 formed by the first end portion 93 and the second end portion 94. The route regulating member 90 also includes first protruding portions 96 that respectively protrude from the inner surfaces of the first end portion 93 and the second end portion 94 toward the exterior member 70 and come into contact with the outer surface of the exterior member 70.

A direction orthogonal to the length direction of the route regulating member 90 is defined as a first direction D1. A direction orthogonal to the length direction of the route regulating member 90 and the first direction D1 is defined as a second direction D2. The length of the route regulating member 90 in the first direction D1 is longer than the length of the route regulating member 90 in the second direction D2. That is, the longitudinal component 92 extends in the first direction D1, and the pair of lateral components 91 extend in the second direction D2. The longitudinal component 92 is longer than the lateral components 91. The insertion slot 95 is open in the second direction D2. That is, the insertion slot 95 is provided between the pair of lateral components 91 on the opposite side from the longitudinal component 92.

With this configuration as well, the route regulating member 90 can be retrofitted to the outer circumference of the exterior member 70 via the insertion slot 95. Detachment of the route regulating member 90 from the exterior member 70 can be suppressed, and there is no need to provide a slit or the like in the exterior member 70. A decrease in the water-sealing performance of the wire harness 10 can thus be suppressed.

Moreover, the length of the route regulating member 90 in the first direction D1 can be shortened as compared with, for example, a configuration in which the insertion slot 95 is open in the first direction D1. Specifically, in the case where the insertion slot is open in the first direction D1, the protruding portions protrude in the first direction D1. This causes an increase in the length of the route regulating member 90 in the first direction D1. The configuration in this example can avoid such a problem and the length of the route regulating member 90 in the first direction D1 can be shortened.

Moreover, for example, in the case of routing the wire harness 10 so as to pass under the floor of the vehicle V, by setting the opening direction of the insertion slot 95 to the antigravity direction, the exterior member 70 can be kept from falling out from the route regulating member 90 and the wire harness 10 can be suitably routed.

In the examples shown in FIGS. 10 and 11, the exterior member 70 is a rectangular corrugated tube as viewed from the length direction of the exterior member 70. Here, the shape need not be an exact rectangular shape, as long as it is mostly rectangular within the range in which the functions and effects according to this embodiment can be achieved. The exterior member 70 may have another flat transverse cross-sectional shape, such as an oval cross-sectional shape. Each of the route regulating members 80 and 90 may have any other shape as long as it is a flat-shape that follows the shape of the outer circumference of the exterior member.

In the examples shown in FIGS. 10 and 11, each electric wire 21 of the electric wire member 20 has a circular transverse cross-sectional shape. However, the electric wire 21 may have a flat transverse cross-sectional shape. This can reduce the size of a gap inside the exterior member 70, for example. In the other examples as well, the electric wire 21 may have a flat transverse cross-sectional shape.
Although the above describes the case where the route regulating member 40 presses the outer surface of the exterior member 30 using each of the first protruding portions 45 and the second protruding portions 46, the route regulating member 40 may not press the outer surface of the exterior member 30 as long as the route of the exterior member 30 can be regulated.
The electric wire member 20 may include one electric wire 21, or three or more electric wires 21.
The braided member 24 may be omitted from the electric wire member 20.
The wire harness 10 may include a plurality of route regulating members 40 spaced apart from each other in the length direction of the exterior member 30.
The route regulating member 40 is not limited to being provided under the floor of the vehicle V. The route regulating member 40 may be provided, for example, in the vehicle interior of the vehicle V, as long as it is a linearly extending part of the wiring route of the electric wire member 20.
As in the example shown in FIG. 2, the route regulating member 40 may be configured to support the exterior member 30 (for example, the annular protrusions 31 of the corrugated tube) at a plurality of points from the outside in the radial direction, in a sectional view of the route regulating member 40. The first protruding portions 45 and the second protruding portions 46 of the route regulating member 40 in FIG. 2 may be referred to as radially inward protruding portions configured to support the exterior member 30 at four points from the outside in the radial direction.
As in the examples shown in FIGS. 5 to 9, the radially inward surface of the route regulating member 40 (or 60) may have a plurality of first protruding portions 45 (or 61) and a concave surface or an inward curved surface excluding the plurality of first protruding portions. As in the examples shown in FIGS. 5 to 9, the route regulating member 40 (or 60) may be configured to support the exterior member 30 (for example, the annular protrusions 31 of the corrugated tube) at three points from the outside in the radial direction using the plurality of first protruding portions 45 (or 61) and another local part (for example, a part of the inward curved surface) besides the plurality of first protruding portions, in a cross-sectional view of the route regulating member 40 (or 60).
As in the examples shown in FIGS. 10 and 11, the radially inward surface of the route regulating member 80 (or 90) may have a plurality of first protruding portions 86 (or 96) and a flat surface or an inward flat portion excluding the plurality of first protruding portions. As in the examples shown in FIGS. 10 and 11, the route regulating member 80 (or 90) may be configured to support the exterior member 70 at three points from the outside in the radial direction using the plurality of first protruding portions 86 (or 96) and another local part (for example, a part of the inward flat surface) besides the plurality of first protruding portions, in a cross-sectional view of the route regulating member 80 (or 90).
As in the example shown in FIG. 2, the radially inward surface of the route regulating member 40 may have a non-protruding surface extending between the first protruding portion 45 and the second protruding portion 46. The non-protruding surface may be referred to as a part or all of the radially inward surface of the route regulating member 40 excluding the first protruding portions 45 and the second protruding portions 46. Part or all of the radially inward surface of the route regulating member 40 excluding the first protruding portions 45 and the second protruding portions 46 need not come into contact with the radially outward surface of the exterior member 30. Part or all of the radially inward surface of the route regulating member 40 excluding the first protruding portions 45 and the second protruding portions 46 may form a gap with the radially outward surface of the exterior member 30. In the examples shown in FIGS. 5 to 11 as well, part or all of the radially inward surface of the route regulating member 40, 60, 80, or 90 excluding the first protruding portions may form a gap with the radially outward surface of the exterior member 30 or 70.

### LIST OF REFERENCE NUMERALS

10 Wire harness
20 Electric wire member
30 Exterior member
40 Route regulating member
41 First end portion
42 Second end portion
43 Connection portion
44 Insertion slot
45 First protruding portion (protruding portion)
46 Second protruding portion
47 Groove portion
48 Inner surface
51 Leading end of first end portion
52 Leading end of second end portion
60 Route regulating member
61 First protruding portion (protruding portion)
62 Insertion slot
63 First end portion
64 Second end portion
65 Connection portion
66 Leading end of first end portion
67 Leading end of second end portion
70 Exterior member
71 Exterior longitudinal component
72 Exterior lateral component
80 Route regulating member
81 Longitudinal component
82 Lateral component
83 First end portion
84 Second end portion
85 Insertion slot
86 First protruding portion (protruding portion)
90 Route regulating member
91 Lateral component
92 Longitudinal component
93 First end portion
94 Second end portion
95 Insertion slot
96 First protruding portion (protruding portion)
D1 First direction
D2 Second direction

1. A wire harness comprising:
an electric wire;
an exterior tube that covers an outer circumference of the electric wire; and
a route regulator that covers part of an outer circumference of the exterior tube in a circumferential direction of the exterior tube and extends in a length direction of the exterior tube, and regulates a wiring route of the electric wire,
wherein the route regulator includes:
an insertion slot that is open in a direction orthogonal to a length direction of the route regulator and extends over an entire length of the route regulator, and is configured to allow insertion of the exterior tube;
a first end and a second end that are located on opposite sides from each other in a circumferential direction of the route regulator and form the insertion slot; and
a protrusion that protrudes from an inner surface of at least one of the first end and the second end toward the exterior tube and comes into contact with an outer surface of the exterior tube.

2. The wire harness according to claim 1,
wherein the protrusion extends in the length direction of the route regulator.

3. The wire harness according to claim 2,
wherein the protrusion extends over the entire length of the route regulator.

4. The wire harness according to claim 1,
wherein the protrusion protrudes from an inner surface of the first end and an inner surface of the second end.

5. The wire harness according to claim 1, wherein:
the protrusion is a first protrusion, and
the route regulator includes:
a connection that connects the first end and the second end; and
a second protrusion that protrudes from an inner surface of the connection toward the exterior tube and contacts the outer surface of the exterior tube.

6. The wire harness according to claim 5,
wherein the second protrusion extends in the length direction of the route regulator.

7. The wire harness according to claim 6,
wherein the second protrusion extends over the entire length of the route regulator.

8. The wire harness according to claim 7,
wherein the route regulator includes a groove that is located on an outer surface of the connection at a part where the second protrusion is located and that extends along the second protrusion over the entire length of the route regulator.

9. The wire harness according to claim 1,
wherein the protrusion protrudes from an inner surface of at least one of a leading end of the first end and a leading end of the second end.

10. The wire harness according to claim 1,
wherein a leading end of the first end and a leading end of the second end are curved as viewed from the length direction of the route regulator.

11. The wire harness according to claim 1,
wherein the protrusion is made of a material softer than another part of the route regulator.

12. The wire harness according to claim 1, wherein:
the route regulator is made of metal, and
the protrusion is formed by bending the route regulator.

13. The wire harness according to claim 1, wherein:
the exterior tube is flat-shaped, and
the route regulator has a flat shape that matches a shape of the outer circumference of the exterior tube.

14. The wire harness according to claim 13, wherein:
a length of the route regulator in a first direction is longer than a length of the route regulator in a second direction, where the first direction is a direction orthogonal to the length direction of the route regulator, and the second direction is a direction orthogonal to the length direction of the route regulator and the first direction, and
the insertion slot is open in the first direction.

15. The wire harness according to claim 13, wherein:
a length of the route regulator in a first direction is longer than a length of the route regulator in a second direction, where the first direction is a direction orthogonal to the length direction of the route regulator, and the second direction is a direction orthogonal to the length direction of the route regulator and the first direction, and
the insertion slot is open in the second direction.

16. The wire harness according to claim 1,
wherein the exterior tube is a corrugated tube that is flexible and is sealed over an entire circumference of the exterior tube.
